(19) United States
(12) Patent Application Publication
(10) Pub. No.: US 2026/0280823 A1
(43) Pub. Date: Sep. 17, 2026

(54) CHANNEL USAGE POLICY FOR NARROWBAND FRQUENCY HOPPERS

(71) Applicant: Cisco Technology, Inc., San Jose, CA (US)

(72) Inventors: Brian D. Hart, Sunnyvale, CA (US); Binita Gupta, San Diego, CA (US); Malcolm Muir Smith, Richardson, TX (US); Matthew S. MacPherson, Apex, NC (US)

(73) Assignee: Cisco Technology, Inc., San Jose, CA (US)

(21) Appl. No.: 19/564,751

(22) Filed: Mar. 12, 2026

Related U.S. Application Data
(60) Provisional application No. 63/839,747, filed on Jul. 7, 2025.
(60) Provisional application No. 63/770,727, filed on Mar. 12, 2025.

(51) Int. Cl. H04L 5/00

(52) U.S. Cl. CPC H04L 5/0092; H04L 5/0012

(57) ABSTRACT

Channel usage for narrowband frequency hoppers may be provided. A plurality of channels in a network environment may be determined for Peer to Peer (P2P) traffic. A usage mode for each of the plurality of channels may be determined. The usage mode may provide an indication of a class of a medium access type recommended to use each channel of the plurality of channels. The listing of the plurality of channels and the usage modes associated with the plurality of channels may be provided to a plurality of client devices of the network environment.

### RELATED APPLICATION

Under provisions of 35 U.S.C. § 119(e), Applicant claims the benefit of U.S. Provisional Application No. 63/770,727, filed Mar. 12, 2025, U.S. Provisional Application No. 63/839,747, filed Jul. 7, 2025, both of which are incorporated herein by reference.

### TECHNICAL FIELD

The present disclosure relates generally to channel usage policy for narrowband frequency hoppers.

### BACKGROUND

In computer networking, a wireless Access Point (AP) is a networking hardware device that allows a Wi-Fi compatible client device to connect to a wired network and to other client devices. The AP usually connects to a router (directly or indirectly via a wired network such as an intranet and/or the Internet) as a standalone device, but it can also be an integral component of the router itself. Several APs may also work in coordination, either through direct wired or wireless connections, or through a central system, commonly called a Wireless Local Area Network (WLAN) controller (WLC). An AP is differentiated from a hotspot, which is the physical location where Wi-Fi access to a WLAN is available.

Prior to wireless networks, setting up a computer network in a business, home, or school often required running many cables through walls and ceilings in order to deliver network access to all of the network-enabled devices in the building. With the creation of the wireless AP, network users are able to add devices that access the network with few or no cables. An AP connects to a wired network, then provides radio frequency links for other radio devices to reach that wired network. Most APs support the connection of multiple wireless devices. APs are built to support a standard for sending and receiving data using these radio frequencies.

### BRIEF DESCRIPTION OF THE FIGURES

The accompanying drawings, which are incorporated in and constitute a part of this disclosure, illustrate various implementations of the present disclosure. In the drawings:

FIG. 1 is a block diagram of an operating environment for channel usage policy for narrowband frequency hoppers;

FIG. 2 is a flow chart of a method for providing channel usage policy for narrowband frequency hoppers;

FIG. 3A is a diagram of an example channel usage element;

FIG. 3B is a diagram of a usage mode field of the example channel usage element of FIG. 3A; and

FIG. 4 is a block diagram of a computing device.

### DETAILED DESCRIPTION

### Overview

Channel usage policy for narrowband frequency hoppers may be provided. A plurality of channels in a network environment may be determined for Peer to Peer (P2P) traffic. A usage mode for each of the plurality of channels may be determined. The usage mode may provide an indication of a class of a medium access type recommended to use each channel of the plurality of channels. The listing of the plurality of channels and usage modes associated with the plurality of channels may be provided to a plurality of client devices of the network environment.

Both the foregoing overview and the following example implementations are examples and explanatory only and should not be considered to restrict the disclosure’s scope, as described and claimed. Furthermore, features and/or variations may be provided in addition to those described. For example, implementations of the disclosure may be directed to various feature combinations and sub-combinations described in the example implementations.

### Example Implementations

The following detailed description refers to the accompanying drawings. Wherever possible, the same reference numbers are used in the drawings and the following description to refer to the same or similar elements. While implementations of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims.

Peer-to-Peer (P2P) traffic contributes substantially to overall traffic congestion and reduction in Quality-of-Service(QoS)/determinism in a network environment. P2P communication is a decentralized network architecture that allows clients or endpoints to interact directly with each other. An example of P2P traffic may include a phone streaming audio to a wireless headphone or a wireless headset using Bluetooth. In another example, P2P traffic in Ultra High Reliability (UHR) may relate to In-Device Coexistence (IDC) such as a phone unlocking a car using Ultra Wide Band (UWB) signal or streaming audio to a car stereo using Bluetooth. Herein P2P traffic may encompass all wireless communications and emissions not related to the traditional Wireless Fidelity (WiFi) use case of communications between an client device and an Access Point (AP) towards providing access to the intranet or the Internet. P2P traffic may include cellular traffic over unlicensed spectrum, Bluetooth (BT) traffic, Ultra-Wide Band (UWB) traffic, Bluetooth Low Energy (BLE) traffic, Zigbee traffic, Matter traffic, etc. The P2P traffic might be sent over unlicensed spectrum such as at 2.4 GHz, 5 GHz, or 6 GHz.

The Institute of Electrical and Electronic Engineers (IEEE) 802.11bn task group may be interested in improving P2P traffic connectivity of a WiFi client with a WiFi AP when the WiFi client is experiencing IDC challenges. A client device (for example, a smartphone, a laptop, etc.) may include multiple radios in a tight volume with no filtering and siloed wireless designs. The client device may be using WiFi with an infrastructure AP but also spraying energy across the band via its BT radio. Embodiments of the disclosure may minimize the interference from the BT radio to the AP and other WiFi APs.

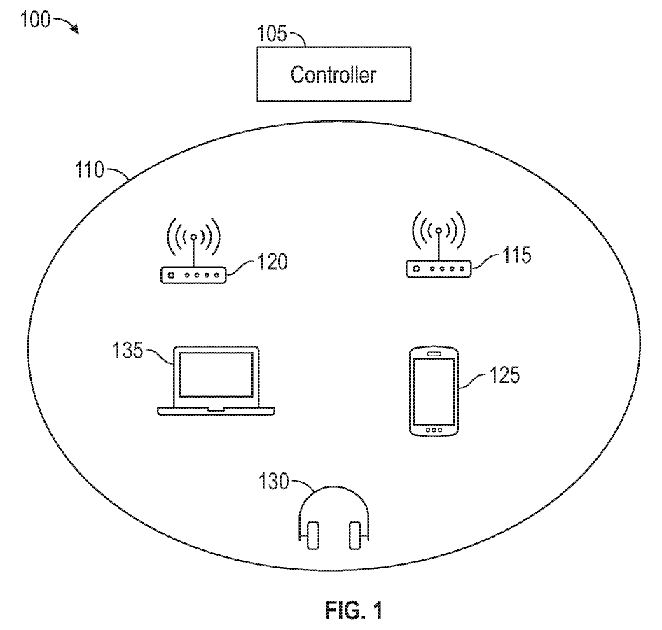

FIG. 1 shows an operating environment 100 for channel usage policy for narrowband frequency hoppers. As shown in FIG. 1, operating environment 100 may include a controller 105 and a coverage environment 110. Coverage environment 110 may comprise, but is not limited to, a Wireless Local Area Network (WLAN) comprising a plurality of APs that may provide wireless network access (e.g., access to the WLAN for client devices). The plurality of APs may comprise a first AP 115 and a second AP 120. The plurality of APs may provide wireless network access to a plurality of client devices or endpoints as they move within coverage environment 110.

The plurality of client devices may comprise, but are not limited to, a first client device 125, a second client device 130, and a third client device 135. One or more of the endpoints may have multiple radios, and the radios may be virtualized to provide for different kinds of connectivity. For example, the wireless device may include one or more radios or virtualized radios for WiFi Internet /intranet connectivity, one or more radios or virtualized radios for WiFi P2P, and other radios for cellular, BT, UWB, Zigbee, Matter, etc.). Ones of the plurality of client devices may comprise, but are not limited to, a smart phone, a Head Mounted Device (HMD), a mouse, a keyboard, a pair of earbuds, a headset, a wireless dock, a personal computer, a tablet device, a mobile device, a telephone, a remote control device, a set-top box, a digital video recorder, an Internet-of-Things (IoT) device, a network computer, a router, an Augmented Reality (AR)/ Virtual Reality (VR)/ Extended Reality (XR)/ Mixed Reality (MR) device, or other similar microcomputer-based device. Each of the plurality of APs may be compatible with specification standards such as, but not limited to, the Institute of Electrical and Electronics Engineers (IEEE) 802.11 specification standard for example.

The plurality of APs and the plurality of client devices may use Multi-Link Operation (MLO) where they are able to transmit and receive across different bands and channels by establishing two or more links to two or more AP radios. These bands may comprise, but are not limited the 2.4 GHz band, the 5 GHz band, the 6 GHz band, and the 60 GHz band.

Controller 105 may comprise a Wireless Local Area Network (LAN) Controller (WLC) and may provision and control coverage environment 110 (e.g., a Wireless LAN (WLAN)). In some examples, controller 105 may include a Radio Resource Manager (RRM). Controller 105 may allow first client device 125, second client device 130, and third client device 135 to join coverage environment 110. In some implementations of the disclosure, controller 105 may be implemented by a Digital Network Architecture Center (DNAC) controller (i.e., a Software-Defined Network (SDN) controller) that may configure information for coverage environment 110 in order to provide channel usage for narrowband frequency hoppers. In other instances, controller’s 105 function may be implemented entirely in software and reside in the cloud, on premises, co-located with an AP, or be distributed across APs or other network elements.

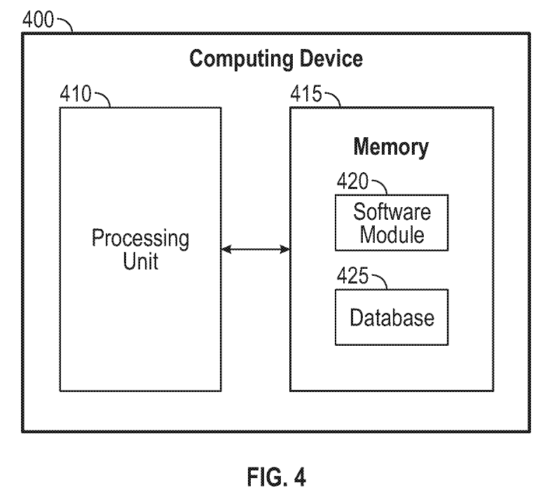

The elements described above of operating environment 100 (e.g., controller 105, first AP 115, second AP 120, first client device 125, second client device 130, and third client device 135) may be practiced in hardware and/or in software (including firmware, resident software, micro-code, etc.) or in any other circuits or systems. The elements of operating environment 100 may be practiced in electrical circuits comprising discrete electronic elements, packaged or integrated electronic chips containing logic gates, a circuit utilizing a microprocessor, or on a single chip containing electronic elements or microprocessors. Furthermore, the elements of operating environment 100 may also be practiced using other technologies capable of performing logical operations such as, for example, AND, OR, and NOT, including but not limited to, mechanical, optical, fluidic, and quantum technologies. As described in greater detail below with respect to FIG. 4, the elements of operating environment 100 may be practiced in a computing device 400.

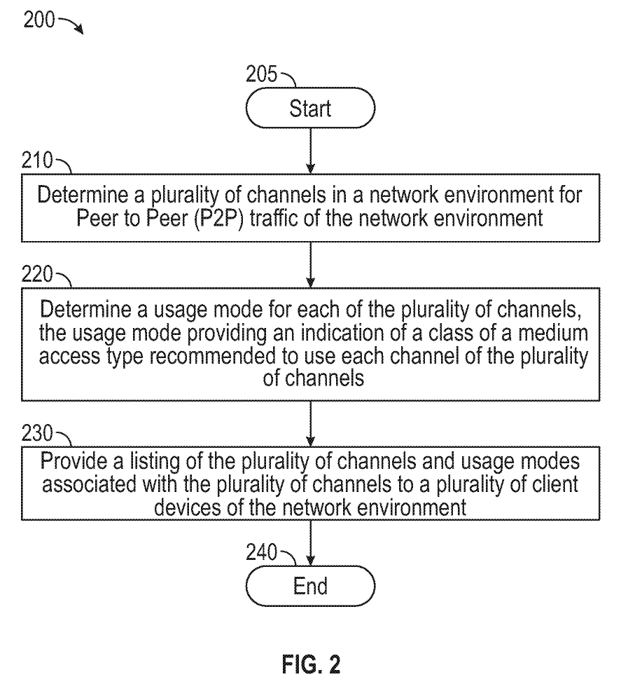

FIG. 2 is a flow chart setting forth the general stages involved in a method 200 consistent with implementations of the disclosure channel usage policy for wireless devices including narrowband frequency hoppers. Method 200 may be implemented using controller 105 as described in more detail above with respect to FIG. 1. In some examples, method 200 may be implemented using the plurality of APs as described in more detail above with respect to FIG. 1. Ways to implement the stages of method 200 will be described in greater detail below.

Method 200 may begin at starting block 205 and proceed to stage 210 where controller 105 may determine a plurality of channels in a network environment (for example, coverage environment 110) for P2P traffic. The P2P traffic may be between first client device 125 (for example, a cellular phone) and second client device 130 (for example, wireless headphones, wireless earphones, car stereo, etc.). Controller 105 may determine that there may be more than a predetermined amount of P2P traffic in coverage environment 110 (currently and/or historically and/or predicted) and may determine to steer the P2P traffic to the plurality of channels so that less P2P traffic is interfering with infrastructure or other traffic in operating environment 110. In some examples, controller 105 may identify the plurality of channels to steer the PbP traffic to and clear the identified plurality of channels of other traffic such as infrastructure traffic between infrastructure APs and client devices. Controller 105 may coordinate with the plurality of APs of coverage environment to clear the plurality of channels identified for the P2P traffic.

Once having determined the plurality of channels in the network environment to steer P2P traffic at stage 210, method 200 may proceed to stage 220 where controller 105 may determine a usage mode for each of the plurality of channels. The usage mode may provide an indication of a class of a medium access type recommended to use each channel of the plurality of channels. In one example, the usage mode may be indicated by assigning one or more values to other wireless systems for different classes of medium access technology and related parameters. Classes may be constructed from a tuple of one or more of the following: Bandwidth (BW), hopping characteristics, Listens before Talking (LbT) characteristics of the corresponding wireless technologies, and a duty cycle. The BW may be one of the following or similar: narrowband, wideband, and UWB. The hopping characteristics may include one of the following or similar: non-hopping, could be hopping (and capable of adaptive frequency hopping to an assigned frequency), is hopping (and capable of adaptive frequency hopping to an assigned frequency). The LbT characteristics may include one of the following or similar: talks (that is, transmits) without first sensing the medium; listens before talking (that is, transmitting); and Carrier Sense Multiple Access with Collision Avoidance (CSMA/CA). Other variants may be included too. The duty cycle may include one of the following or similar: low, medium, and high. Additional characteristics may be used to create the tuple for the classes. In some implementations, adjacent channels may be allocated to the same class of medium access type. This may not preclude that, as well, sets of (non-contiguous) channels already defined for advertising by wireless technologies might be allocated to the same class of medium access type too.

In one example, a value of 6 for the usage mode (that is, usage mode 6) may be defined to indicate a channel recommended for a medium access technology that uses narrowband channels (that is, BW=narrowband) and channel hops (that is, hopping = 1). The class tuple for the usage mode 6 may be defined as (narrowband, isHopping = 1). The usage mode 6 and an associated channel therefore may be recommended for the BT radio or for the P2P traffic over BT radio. In another example, a value of 7 for the usage mode (that is, usage mode 7) may be defined to indicate a channel recommended for a medium access technology that uses narrowband channels (that is, BW=narrowband) and channel does not hop (that is, hopping = 0). The class tuple for the usage mode 7 may be defined as (narrowband, isHopping = 0). The usage mode 7 and an associated channel may be recommended for the P2P traffic comprising BLE advertising traffic. Alternatively, this may be lumped with usage mode 6, with i.e., hopping = could-be-hopping. In yet another example, a value of 8 for the usage mode (that is, usage mode 8) may be defined to indicate a channel recommended for a medium access technology that uses wideband BW channels (that is, BW=wideband) and a high duty cycle (that is, dutyCycle = high). The class tuple for the usage mode 8 may be defined as (narrowband, dutyCycle = 1). This value and associated channel may be recommended for New Radio-Unlicensed (NRU) traffic.

After determining the usage mode for each of the plurality of channels at stage 220, method 200 may proceed to stage 230 where controller 105 may provide the listing of the plurality of channels and usage mode associated with the plurality of channels to a plurality of client devices of the network environment. In some examples, the usage modes may be provided in a channel usage element of the plurality of channels. The channel usage element may be sent by the plurality of APs in beacons, probe responses, association frames, reassociation frames, BSS Transition Management (BTM) query, BTM request, Neighbor Report (NR) response frame, channel usage response frame, other management frame, etc. In some instances, an AP may only send the channel usage signal in response to an explicit request by the client device, such as when the client device sends a channel usage request frame. The channel usage request frame may include a channel usage element containing a usage mode field signifying narrow band frequency hopping. In the response, there may be one channel usage element for each distinct determined usage mode and subset of channels; and the set of channel usage elements may span a plurality of channels. In another implementation, the set of usage modes may be determined first, and then suitable channels may be identified for each usage mode; then once again one channel usage element may be transmitted for each usage mode. In yet another implementation, a non-WiFi radio (perhaps collocated with an AP) in communication with controller 105 may use non-WiFi wireless technologies (such as BT, BLE, UWB, NRU) to advertise or otherwise report the semantics expressed by the channel usage elements.

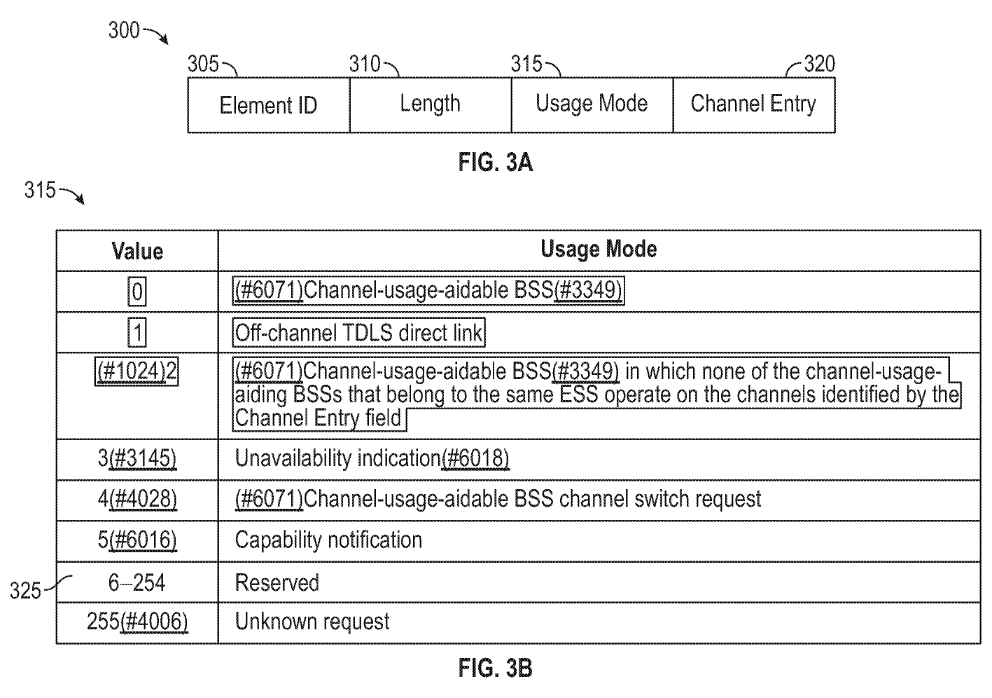

FIG. 3A is a diagram of an example channel usage element 300. channel usage element 300 may be transmitted by an IEEE 802.11 AP. If an AP device includes not only IEEE 802.11 radios but also other radio technologies (for example, such as BT, BLE, UWB, etc.), then other signaling formats more suited to those other radio technologies may be used. As shown in FIG. 3A, channel usage element 300 may include a plurality of fields, for example, an element Identifier (ID) field 305, a length field 310, a usage mode field 315, and a channel entry field 320. A length of each of the plurality of fields of channel usage element 300 may be predetermined, for example, 1 octet. A single channel usage element 300 may be included for each recommended channel or for more than one recommended channel. A set of (smaller, contiguous) channels may be indirectly recommended by listing a single (wider) channel that is the union of the smaller channels. An identifier or identity of each of the recommended channels may be provided in channel entry field 320.

Usage mode field 315 may be used to provide the usage mode for one or more channels. FIG. 3B is a diagram of usage mode field 315 of channel usage element 300 of FIG. 3A. As shown in FIG. 3B, usage mode field 315 may include 256 usage mode values each of which may be used to define a unique usage mode. Usage mode values 6-254 may be presently-reserved (indicated as 325) and may be unreserved and assigned for new purposes such as indicating usage modes for each of the plurality of channels recommended for the P2P traffic associated with different medium access technology. Once controller 105 provides the listing of the plurality of channels and the usage modes to the plurality of client devices at stage 230, method 200 may then terminate at END stage 240.

A client device of coverage environment 110, for example, first client device 125 may receive the listing of the plurality of channels and the usage modes associated with the plurality of channels and may determine that a usage mode is applicable to a radio of first client device 125. First client device 125, in response to determining that the usage mode is applicable to the radio of first client device 125, may: a) start any new P2P activity to a recommended channel in the usage mode, b) switch the radio of ongoing P2P activity to a recommended channel in the usage mode and/or signal to a peer device the client device’s interest/recommendation to switch their communications to a recommended channel in the usage mode. For example, first client device 125 may receive the usage mode 6 (which may be applicable to a BT radio) in channel usage element 300 from first AP 115. First client device 125 may be already using or is about to use its BT radio to communicate with second AP 130 (that is, a wireless headphone). First client device 125 may use the recommended channel in the usage mode 6 and start and thereafter operate/switch/request a switch of the BT radio to the recommended channel.

In some implementations, first client device 125 may determine, in response to determining that the usage mode is application to the radio of first client device 125, that a recommended channel in the usage mode is not more congested than other channels available for the P2P traffic. First client device 125 then may start, switch, or request a switch, in response to determining that the recommended channel in the usage mode is not more congested than the other channels available for the P2P traffic, the radio to a channel recommended in the usage mode

For instance, first client device 125 may be recommended to use some, many, or all channels in Unlicensed National Information Infrastructure (UNII) 3 and UNII 1 since they may commonly be using these already. Narrowband frequency hoppers, on the other hand, may be recommended to use band-edge spectrum and/or some, many, or all channels in UNII 4 as UNII 4 spectrum is harder to use by WiFi7+ devices due to filters for MLO at 5 GHz and 6 GHz.

A client device, for example, first client device 125 with multiple radios, upon receipt of the channel usage information, may, for each radio for whom there is an applicable channel usage element, optionally check that the channel recommendation is consistent across neighboring APs. In addition, first client device 125 may optionally check that the recommended channel is not more congested than other channels. First client device 125 then may be biased to start using or request to switch their channels to use to within the recommended channel list. If first client device 125 forms a new connection, then first client device 125 may be biased to start the new connection on one or more channels within the recommended channel list. In some examples, where the bias may be governed by external factors (for example, Mobile Device Management (MDM) or a group policy) may cause that recommendations by certain Service Set Identifiers (SSIDs) may have a higher weight. For example, a recommendation from an AP from the user’s employer may have higher weight. Also, a recommendation from an AP to which the client device is attached to may have a higher weight than that from other APs.

As discussed above, to help steer narrowband frequency hoppers away from channels used by infrastructure or enterprise APs for critical traffic, controller 105 may vacate some channels from use by, for example, from non-P2P traffic, or by the infrastructure or enterprise APs and recommend vacated channels for narrowband frequency hoppers. Multi-radio devices like smartphones and laptops may hear the policy and may react to it or consider it especially while being connected to the AP advertising the policy. Also, this same technique may be used for other kinds of wireless systems with characteristics that make them unfriendly sharers with the IEEE 802.11 (including both infrastructure 802.11 and P2P 802.11).

In some examples, APs of coverage environment 110 (for example, first AP 115) may also include extra radios, such as, for BT, UWB, Zigbee, Matter, or NRU. Each of these radios may support an advertisement mechanism and/or vendor specific signaling. First AP 115 may have a channel usage policy (determined by itself or controller 105) and may transmit the channel usage policy over the BT, UWB, Zigbee, Matter, NRU, etc. as well as, or instead of, over the IEEE 802.11. The message may be trusted at recipients (for example, first client device 125) in the same way as other messages from first AP’s 115 non-WiFi radios may be trusted. In one embodiment, a security mechanism may be included so that the authenticity of the message may be verified by the receiver. The security mechanism may include, in one example, a certificate chain, where a trusted certificate authority may provide some assurance that the transmitter of the signal is a known entity such as the venue owner or tenant of the facility in which first AP 115 may be installed. The entity operating the RRM function, such as controller 105, may remain a natural source of the channel usage policy, and the RRM may extend itself to reduce congestion and collisions to multiple unlicensed wireless technologies (such has all technologies on which advertisements are being sent).

A recipient client device may treat the information carried by the BT, UWB, Zigbee, or Matter in a similar way as the signal transmitted by an IEEE 802.11 AP. That is, after discarding signal from any nearby transmitting devices that fail a security check, the receiving client device may assign a greater weight on a transmitting device that may support and pass security, a greater weight on a transmitting device that the recipient client device is connected to (and has a constructive experience with), a greater weight on a transmitting device that is heard more loudly, and/or a greater weight on multiple devices reporting the same channel usage policy (via the same or different wireless technologies). Once the signaled policy is determined, the receiving client device may use the recommendation as some kind of bias or determinant of its behavior, such as on what channel they operate their P2P communications.

FIG. 4 shows computing device 400. As shown in FIG. 4, computing device 300 may include a processing unit 410 and a memory unit 415. Memory unit 415 may include a software module 420 and a database 425. While executing on processing unit 410, software module 420 may perform, for example, processes for channel usage policy for narrowband frequency hoppers as described above with respect to FIG. 2. Computing device 400, for example, may provide an operating environment for controller 105, first AP 115, second AP 120, first client device 125, second client device 130, or third client device 135. Controller 105, first AP 115, second AP 120, first client device 125, second client device 130, or third client device 135 may operate in other environments and are not limited to computing device 400.

Computing device 400 may be implemented using a Wi-Fi access point, a tablet device, a mobile device, a smart phone, a telephone, a remote control device, a set-top box, a digital video recorder, a cable modem, a personal computer, a network computer, a mainframe, a router, a switch, a server cluster, a smart TV-like device, a network storage device, a network relay device, or other similar microcomputer-based device. Computing device 400 may comprise any computer operating environment, such as hand-held devices, multiprocessor systems, microprocessor-based or programmable sender electronic devices, minicomputers, mainframe computers, and the like. Computing device 400 may also be practiced in distributed computing environments where tasks are performed by remote processing devices. The aforementioned systems and devices are examples, and computing device 300 may comprise other systems or devices.

Implementations of the disclosure, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, implementations of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a Random Access Memory (RAM), a Read-only Memory (ROM), an Erasable Programmable Read-only Memory (EPROM or Flash memory), an optical fiber, and a portable Compact Disc Read-only Memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

While certain implementations of the disclosure have been described, other implementations may exist. Furthermore, although implementations of the present disclosure have been described as being associated with data stored in memory and other storage mediums, data can also be stored on or read from other types of computer-readable media, such as secondary storage devices, like hard disks, floppy disks, or a CD-ROM, a carrier wave from the Internet, or other forms of RAM or ROM. Further, the disclosed methods’ stages may be modified in any manner, including by reordering stages and/or inserting or deleting stages, without departing from the disclosure.

Furthermore, implementations of the disclosure may be practiced in an electrical circuit comprising discrete electronic elements, packaged or integrated electronic chips containing logic gates, a circuit utilizing a microprocessor, or on a single chip containing electronic elements or microprocessors. Implementations of the disclosure may also be practiced using other technologies capable of performing logical operations such as, for example, AND, OR, and NOT, including but not limited to, mechanical, optical, fluidic, and quantum technologies. In addition, implementations of the disclosure may be practiced within a general purpose computer or in any other circuits or systems.

Implementations of the disclosure may be practiced via a system-on-a-chip (SOC) where each or many of the element illustrated in FIG. 1 may be integrated onto a single integrated circuit. Such an SOC device may include one or more processing units, graphics units, communications units, system virtualization units and various application functionality all of which may be integrated (or “burned”) onto the chip substrate as a single integrated circuit. When operating via an SOC, the functionality described herein with respect to implementations of the disclosure, may be performed via application-specific logic integrated with other components of computing device 300 on the single integrated circuit (chip).

Implementations of the present disclosure, for example, are described above with reference to block diagrams and/or operational illustrations of methods, systems, and computer program products according to implementations of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While the specification includes examples, the disclosure’s scope is indicated by the following claims. Furthermore, while the specification has been described in language specific to structural features and/or methodological acts, the claims are not limited to the features or acts described above. Rather, the specific features and acts described above are disclosed as example for implementations of the disclosure.

What is claimed is:

1. A method comprising:
determining a plurality of channels in a network environment for Peer to Peer (P2P) traffic of the network environment;
determining a usage mode for each of the plurality of channels, the usage mode providing an indication of a class of a medium access type recommended for each channel of the plurality of channels; and
providing a listing of the plurality of channels and usage modes associated with the plurality of channels to a plurality of client devices of the network environment.

2. The method of claim 1, wherein the class of the medium access type is constructed from a tuple of one or more of: bandwidth, hopping characteristics, Listens before Talking (LbT) characteristics, and a duty cycle.

3. The method of claim 1, wherein providing the listing of the plurality of channels and the usage modes associated with the plurality of channels comprises providing each of the usage modes in a usage mode field of a channel usage element.

4. The method of claim 1, wherein determining the plurality of channels in the network environment for the P2P traffic comprises vacating the plurality or a subset of the plurality of channels by non-P2P traffic for the P2P traffic.

5. The method of claim 1, wherein the medium access type comprises one of the following: Bluetooth, Bluetooth Low Energy (BLE), Ultra Wide Band (UWB), Zigbee, and Matter.

6. The method of claim 1, further comprising:
allocating two or more adjacent channels to a same class of the medium access type.

7. The method of claim 1, further comprising:
receiving, by a first client device of the plurality of client devices, the listing of the plurality of channels and the usage modes associated with the plurality of channels;
determining, by the first client device, that a first usage mode of the usage modes is applicable to a first radio of the first client device;
in response to determining that the first usage mode is applicable to the first radio of the first client device:
starting, by the first client device, any new P2P communication on at least one channel associated with the first usage mode; and
switching, by the first client device, the first radio of an ongoing P2P traffic to the at least one channel associated with the first usage mode.

8. A system comprising:
a memory storage; and
a processing unit disposed in a first computing device and coupled to the memory storage, wherein the processing unit is operative to:
determine a plurality of channels in a network environment for Peer to Peer (P2P) traffic;
determine a usage mode for each of the plurality of channels, the usage mode providing an indication of a class of a medium access type recommended use to each channel of the plurality of channels; and
provide a listing of the plurality of channels and usage modes associated with the plurality of channels to a plurality of client devices of the network environment.

9. The system of claim 8, wherein the class of the medium access type is constructed from a tuple of two or more of: bandwidth, hopping characteristics, Listens before Talking (LbT) characteristics, and a duty cycle.

10. The system of claim 8, wherein the processing unit being operative to provide the usage modes comprises the processing unit being operative to provide the usage modes in a usage mode field of the channel usage element.

11. The system of claim 8, wherein the processing unit being operative to determine the plurality of channels in the network environment for the P2P traffic comprises the processing unit being operative to vacate the plurality of channels by non-P2P traffic for the P2P traffic.

12. The system of claim 8, wherein the medium access type comprises one of the following: Bluetooth, Bluetooth Low Energy (BLE), Ultra Wide Band (UWB), Zigbee, and Matter.

13. The system of claim 8, wherein the system comprises a multi radio device.

14. A non-transitory computer-readable medium that stores a set of instructions which when executed perform a method executed by the set of instructions comprising:
determining a plurality of channels in a network environment for Peer to Peer (P2P) traffic;
determining a usage mode for each of the plurality of channels, the usage mode providing an indication of a class of a medium access type recommended to use each channel of the plurality of channels; and
providing a listing of the plurality of channels and usage modes associated with the plurality of channels to a plurality of client devices of the network environment.

15. The non-transitory computer-readable medium of claim 14, wherein the class of the medium access type is constructed from a tuple of one or more of: bandwidth, hopping characteristics, Listens before Talking (LbT) characteristics, and a duty cycle.

16. The non-transitory computer-readable medium of claim 14, wherein providing the usage modes comprises providing the usage modes in a usage mode field of the channel usage element.

17. The non-transitory computer-readable medium of claim 14, wherein determining the plurality of channels in the network environment for the P2P traffic comprises vacating the plurality of channels by non-P2P traffic for the P2P traffic.

18. The non-transitory computer-readable medium of claim 14, wherein the medium access type comprises one of the following: Bluetooth, Bluetooth Low Energy (BLE), Ultra Wide Band (UWB), Zigbee, and Matter.

19. The non-transitory computer-readable medium of claim 14, further comprising:
allocating two or more adjacent channels to a same class of the medium access type.

20. The non-transitory computer-readable medium of claim 14, further comprising:
receiving, by a first client device of the plurality of client devices, the listing of the plurality of channels and the usage modes associated with the plurality of channels;
determining, by the first client device, that a first usage mode of the usage modes is applicable to a first radio of the first client device;
in response to determining that the first usage mode is applicable to the first radio of the first client device:
starting, by the first client device, any new P2P traffic on a first channel associated with the first usage mode; and
switching, by the first client device, the first radio of an ongoing P2P traffic to the first channel associated with the first usage mode.
